(19) United States
(12) Patent Application Publication
(10) Pub. No.: US 2015/0286999 A1
(43) Pub. Date: Oct. 8, 2015

(54) METHOD AND SYSTEM FOR TRANSACTION PROCESSING

(71) Applicant: EBAY INC., San Jose, CA (US)

(72) Inventors: Damon Charles Hougland, San Jose, CA (US); Jason Alexander Korosec, Morgan Hill, CA (US); Osama Mostafa Bedier, San Jose, CA (US); Srinivasa Pasupulati, Cupertino, CA (US)

(21) Appl. No.: 14/745,209

(22) Filed: Jun. 19, 2015

Related U.S. Application Data
(63) Continuation of application No. 12/114,870, filed on May 5, 2008.

(51) Int. Cl. G06Q 20/10; G06F 17/21; H04L 29/08

(52) U.S. Cl. CPC G06Q 20/10; H04L 67/10; G06F 17/21

(57) ABSTRACT

Methods and system for transaction processing are described. In one embodiment, a plurality of default parameters may be configured for value transfer. A transfer request including a transfer amount and a user account identifier may be received. One or more of the plurality of default parameters may be selected. The transfer request may be processed in the transfer amount based on the user account identifier and the one or more selected default parameters.

### CROSS-REFERENCE TO RELATED APPLICATION

This application is a continuation of U.S. patent application Ser. No. 12/114,870, filed May 5, 2008, which is incorporated herein by reference in its entirety.

### BACKGROUND

A developer ordinarily utilizes detailed information regarding operations of a payment processor to enable applications to transfer value using the payment processor.

### BRIEF DESCRIPTION OF THE DRAWINGS

Some embodiments are illustrated by way of example and not limitation in the figures of the accompanying drawings in which:

FIG. 1 is a block diagram of a system, according to example embodiments;

FIG. 2 is a block diagram of a transaction request processing subsystem may be deployed within the system of FIG. 1 according to an example embodiment;

FIG. 3 is a block diagram of a transfer request generation subsystem may be deployed within the system of FIG. 1 according to an example embodiment;

FIG. 4 is an example flowchart illustrating a method for transaction request processing according to an example embodiment;

FIG. 5 is an example flowchart illustrating a method for pre-processing according to an example embodiment;

FIGS. 6 and 7 are example flowcharts illustrating a method for transfer request processing according to example embodiments;

FIG. 8 is an example flowchart illustrating a method for further processing according to an example embodiment;

FIG. 9 is an example flowchart illustrating a method for transfer request generation according to an example embodiment;

FIG. 10 is a network diagram depicting a network system, according to one embodiment, having a client server architecture configured for exchanging data over a network;

FIG. 11 is a block diagram illustrating an example embodiment of multiple network and marketplace applications, which are provided as part of the network-based marketplace; and

FIG. 12 is a block diagram diagrammatic representation of machine in the example form of a computer system within which a set of instructions for causing the machine to perform any one or more of the methodologies discussed herein may be executed.

### DETAILED DESCRIPTION

Example methods and systems for transaction processing are described. In the following description, for purposes of explanation, numerous specific details are set forth in order to provide a thorough understanding of example embodiments. It will be evident, however, to one skilled in the art that the present invention may be practiced without these specific details.

In an example embodiment, a plurality of default parameters may be configured for value transfer. A transfer request including a transfer amount and a user account identifier may be received. One or more of the plurality of default parameters may be selected. The transfer request may be processed in the transfer amount based on the user account identifier and the one or more selected default parameters.

In an example embodiment, a user request for a transaction may be received from a requesting user. The user request may be associated with a transfer amount and a user account identifier. At least one override parameter may be designated based on the user request. A transfer request including a transfer amount, a user account identifier, and at least one override parameter may be generated. The transfer request may be provided to a payment processor.

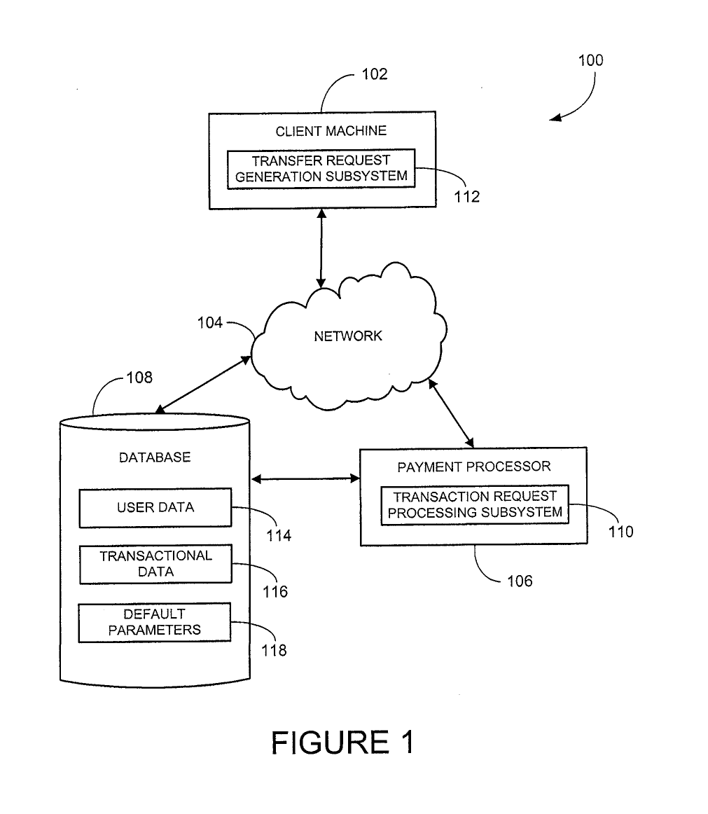

FIG. 1 illustrates an example system 100 in which a client machine 102 may be in communication with a payment processor 106 over a network 104. An operator of the client machine 102 may communicate with the payment processor 106 to transfer value from one user to another. Examples of the client machine 102 include a set-top box (STB), a receiver card, a mobile telephone, a personal digital assistant (PDA), a display device, a portable gaming unit, and a computing system; however other devices may also be used.

The network 104 over which the client machine 102 and the payment processor 106 are in communication may include a Global System for Mobile Communications (GSM) network, an Internet Protocol (IP) network, a Wireless Application Protocol (WAP) network, a WiFi network, or a IEEE 802.11 standards network as well as various combinations thereof. Other conventional and/or later developed wired and wireless networks may also be used.

The payment processor 106 may be a facilitator of value transfer. For example, the payment processor 106 may be, by way of example, PayPal.com. The payment processor 106 may include a transaction request processing subsystem 110 to process transaction requests. The payment processor 106 may also be in communication with a database 108. The database 108 may include user data 114, transactional data 116, and/or a number of default parameters. The user data 114 may include information regarding users of the payment processor 106. The transactional data 116 may include information regarding transactions conducted by the payment processor 106. For example, the sale of an item from one user to another may be stored in the transactional data 116. The default parameters 118 may be used by the transaction request processing subsystem 110 when processing transfer requests received from the client machine 102. For example, the default parameters 118 may include a default currency, a default source user, a default timing of the transaction, a default currency amount, a default number of target users, or the like. Other types of default parameters may also be used.

A transfer request generation subsystem 112 may be deployed within the client machine 102 to enable generation of the transfer requests received by the payment processor 106. The transfer requests may be generated by on requests received from users or may be otherwise generated.

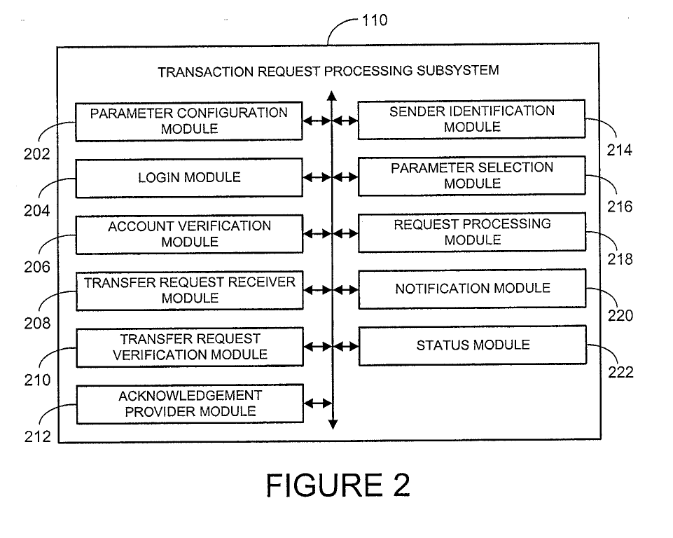

FIG. 2 illustrates an example transaction request processing subsystem 110 that may be deployed in the payment processor 106 of the system 100 (see FIG. 1) or otherwise deployed in another system. The transaction request processing subsystem 110 may include a parameter configuration module 202, a login module 204, an account verification module 206, a transfer request receiver module 208, a transfer request verification module 210, an acknowledgement provider module 212, a sender identification module 214, a parameter selection module 216, a request processing module 218, a notification module 220, and/or a status module 222. Other modules may also be included.

The parameter configuration module 202 configures a number of the default parameters 118 for value transfer. The default parameters may be stored in the database 108 or may be otherwise retained. The login module 204 receives user login information and verifies access rights of a sender of the user login information.

The account verification module 206 receives a verification request including the user account identifier, identifies a user account associated with the user account identifier, and provides account verification responsive to the receiving of the verification request and the identifying of the user account. The user account identifier may include an e-mail address, a telephone number, a token, or the like.

The transfer request receiver module 208 receives a transfer request including a transfer amount, a user account identifier, and/or an override parameter. The override parameter may include a currency base, a target user identifier, a source user identifier, a fee transfer indicator, or the like. The receiving of the transfer request may be based on the providing of the account verification. The transfer request may be in a programmable scripting language or a different format.

The transfer request verification module 210 verifies the transfer request. The acknowledgement provider module 212 provides an acknowledgement regarding the receiving of the transfer request. The providing of the acknowledgement may be based on verification of the transfer request.

The sender identification module 214 identifies a sender of the transfer request. The parameter selection module 216 selects one or more of the default parameters 118. The default parameters 118 may be selected from the database 108 or otherwise selected.

The request processing module 218 processes the transfer request in the transfer amount based on processing of the transfer request, the user account identifier, on identification of the sender of the transfer request and/or one or more selected default parameters.

The processing of the transfer request may include identifying a target user account associated with the user account identifier, reducing a source user account by the transfer amount and increasing the target user account value by the transfer amount. The processing of the transfer request may include identifying a source user account associated with the user account identifier, reducing the source user account by the transfer amount, and increasing a target user account value by the transfer amount. Other processing of the transfer request may also be performed. The processing of the transfer request may be based on the verifying of the access rights.

The status module 222 receives a status address, generates a status identifier to indicate a status of the processing of the transfer request, and provides the status identifier to the status address to provide a status notification.

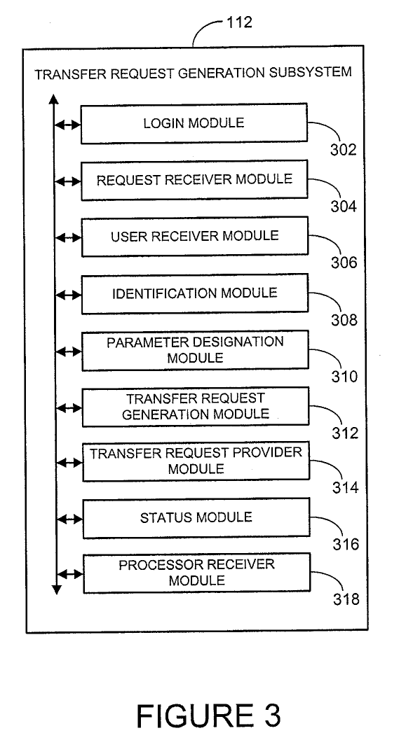

FIG. 3 illustrates an example transfer request generation subsystem 112 that may be deployed in the client machine 102 of the system 100 (see FIG. 1) or otherwise deployed in another system. The transfer request generation subsystem 112 may include a login module 302, a request receiver module 304, a user receiver module 306, an identification module 308, a parameter designation module 310, a transfer request generation module 312, a transfer request provider module 314, a status module 316, and/or a processor receiver module 318. Other modules may also be included.

The login module 302 provides user login information to the payment processor 106. The request receiver module 304 receives a user request for a transaction from a requesting user. The user request may be associated with a transfer amount and a user account identifier.

The user receiver module 306 receives the transfer amount and/or the account identifier from the requesting user. The identification module 308 identifies the transfer amount based on the request for the transaction and/or the user account identifier based on the request for the transaction. The parameter designation module 310 designates at least one override parameter based on the user request.

The transfer request generation module 312 generates a transfer request including a transfer amount, a user account identifier, and at least one override parameter. The transfer request may be generated in programmable scripting language based on the request or may be otherwise generated. The transfer request provider module 314 provides the transfer request to a payment processor.

The status module 316 provides a status address to the payment processor 106, receives a status identifier from the payment processor 106 through the status address, and/or provides a status notification to the requesting user based on the receiving of the status identifier. The processor receiver module 318 receives a notification from the payment processor 106 based on processing of the transfer request and/or an acknowledgement from the payment processor 106 based on the sending of the transfer request.

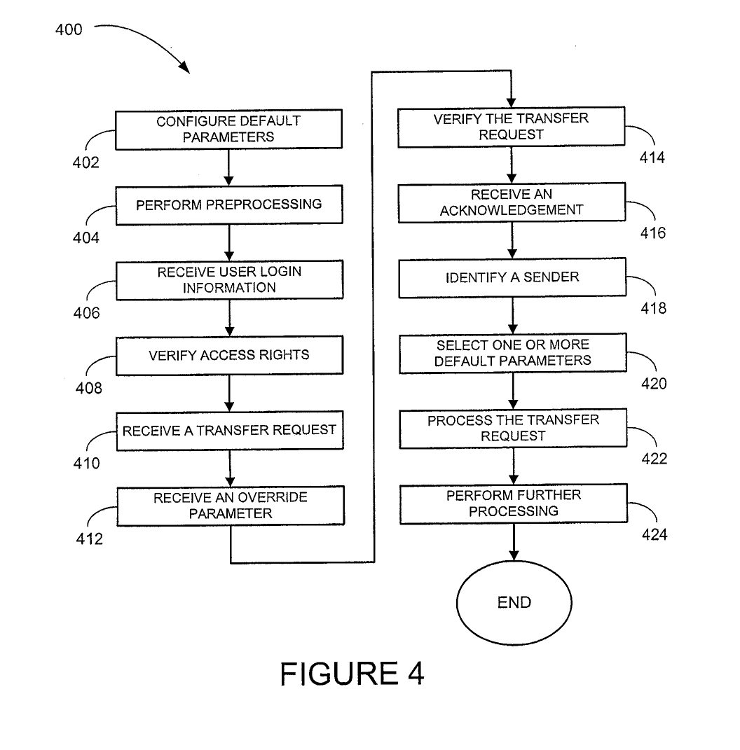

FIG. 4 illustrates a method 400 for transaction request processing according to an example embodiment. The method 400 may be performed by the payment processor 106 of the system 100 (see FIG. 1) or otherwise performed.

In an example embodiment, the use of the default parameters 118 may enable simplification of receiving and processing transfer requests. The simplification may enable developers and others to incorporate payment processing technology at a reduced time and at a reduced cost by avoiding the learning of the complexities of a programming language or a web server.

A number of the default parameters 118 for value transfer are configured at block 402. The default parameters 118 may be accessed from the database 108 or otherwise accessed. Preprocessing may be performed at block 404. An amount of the value transfer amount may be in real currency, virtual currency, points, credits, miles, or the like.

User login information may be received at block 406. Access rights of a sender of the user login information may be verified at block 408.

A transfer request including a transfer amount and a user account identifier is received at block 410. The receiving of the transfer request may be based on the preprocessing. The transfer request may be received from the application or may be otherwise received.

The transfer request may be a programmable scripting language or a different language. In an example embodiment, the transfer request in the programming scripting language may be a simple, single line plain text command regarding to whom the value transfer is to be sent and/or from who the value transfer is to be provided. For example, the transfer request in programmable scripting language may be “pay 20 from damon@paypal.com to jason@paypal.com”. The transfer request may include a single line of programming or multiple lines of programming.

One or more override parameters may be received with the transfer request at block 412. The override parameters may include, by way of example, a currency base, a target user identifier, a source user identifier, a fee transfer indicator, or the like. For example, the transfer request in programmable scripting language with an override parameter may be “pay 20 from damon@paypal.com to jason@paypal.com where fees=sender”. The override parameters may enable customization of the transfer request. The override parameters may be used instead of selected default parameters or in place of selecting default parameters 118.

The transfer request may be verified at block 414. An acknowledgement regarding the receiving of the transfer request may be provided at block 416. The acknowledgement may be provided based on verification of the transfer request.

A sender of the transfer request may be identified at block 418. One or more of the default parameters 118 are selected at block 420. The default parameters 118 may be selected from the database 108 or otherwise selected.

At block 422, the transfer request is processed in the transfer amount based on the user account identifier, identification of the sender, verification of access rights, receipt of the override parameter and/or the one or more selected default parameters.

Further processing may be performed at block 424. In an example embodiment, an application may be notified during the operations performed at block 424 based on the processing of the transfer request at block 424.

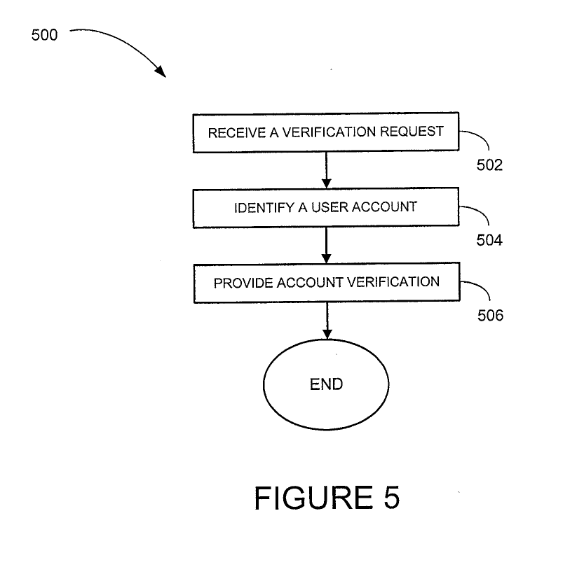

FIG. 5 illustrates a method 500 for pre-processing according to an example embodiment. The method 500 may be performed at block 404 (see FIG. 4) or otherwise performed.

A verification request including the user account identifier may be received at block 502. A user account associated with the user account identifier may be identified at block 504. At block 506, account verification may be provided responsive to the receiving of the verification request and the identifying of the user account.

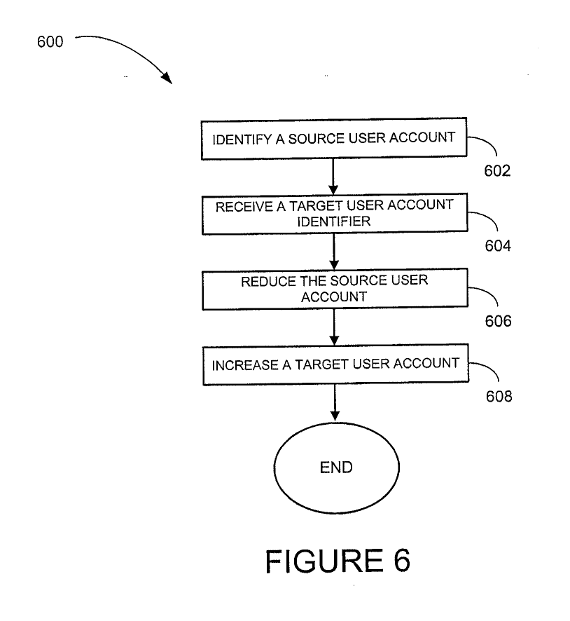

FIG. 6 illustrates a method 600 for transfer request processing according to an example embodiment. The method 600 may be performed at block 422 (see FIG. 4) or otherwise performed.

A source user account associated with the user account identifier may be identified at block 602. A target user account identifier in the transfer request may be received at block 604. The target user account identifier may be capable of being used to identify the target user account. The source user account and/or the target user account may be, by way of example, a balance account, a savings account, a checking account, or a credit card account. Other user accounts may also be used.

The source user account may be reduced by the transfer amount at block 606. A target user account value may be increased by the transfer amount at block 608.

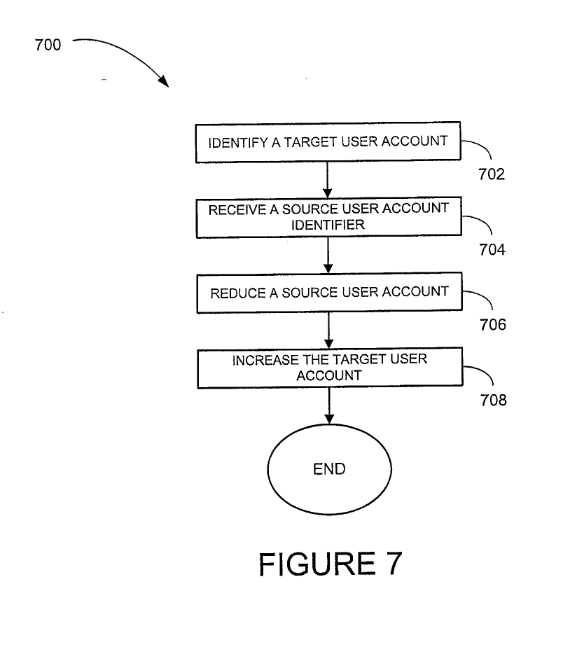

FIG. 7 illustrates a method 700 for transfer request processing according to an example embodiment. The method 700 may be performed at block 422 (see FIG. 4) or otherwise performed.

A target user account associated with the user account identifier may be identified at block 702. A source user account identifier may be received in the transfer request at block 704. The source user account identifier may be capable of being used to identify the source user account.

A source user account may be reduced by the transfer amount at block 706. The target user account value may be increased by the transfer amount at block 708.

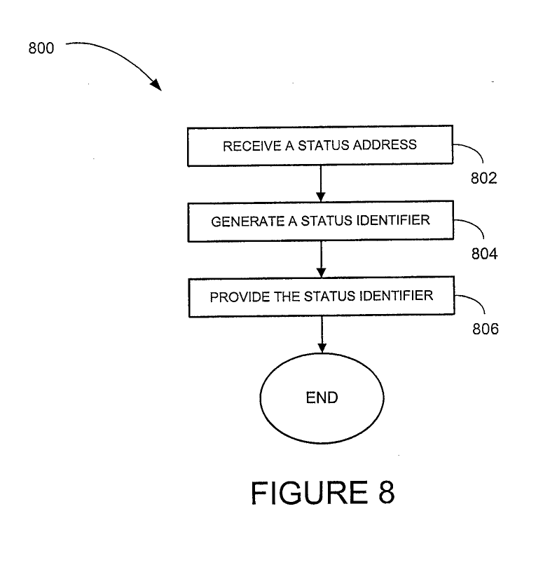

FIG. 8 illustrates a method 800 for further processing according to an example embodiment. The method 800 may be performed at block 424 (see FIG. 4) or otherwise performed.

A status address may be received at block 802. A status identifier may be generated to indicate a status of the processing of the transfer request at block 804. At block 806, the status identifier may be provided to the status address to provide a status notification.

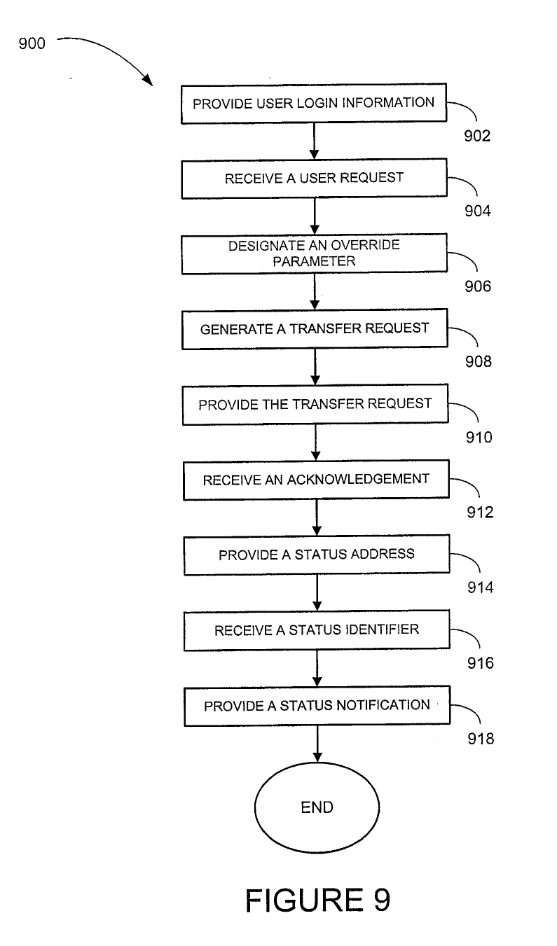

FIG. 9 illustrates a method 900 for transfer request generation according to an example embodiment. The method 900 may be performed by the client machine 102 of the system 100 (see FIG. 1) or otherwise performed.

User login information may be provided to the payment processor 106 at block 902. A user request for a transaction is received from a requesting user at block 904. The user request may be associated with a transfer amount and a user account identifier. The user account identifier may include an e-mail address, a telephone number, a token, or the like.

The transfer amount may be identified based on the request for the transaction, received from the requesting user, or otherwise obtained. The user account identifier may be identified based on the request for the transaction, received from the requesting user, or otherwise obtained.

At least one override parameter is designated based on the user request at block 906. A transfer request is generated at block 908. The transfer request may include the transfer amount, the user account identifier and/or at least one override parameter. The transfer request may be generated in programmable scripting language or may be otherwise generated.

The transfer request is provided to the payment processor 106 at block 910. At block 912, an acknowledgement may be received from the payment processor 106 based on the sending of the transfer request.

A status address may be provided to the payment processor 106 at block 914. A status identifier may be received from the payment processor 106 through the status address at block 916. A status notification may be provided to the requesting user based on the receiving of the status identifier at block 918.

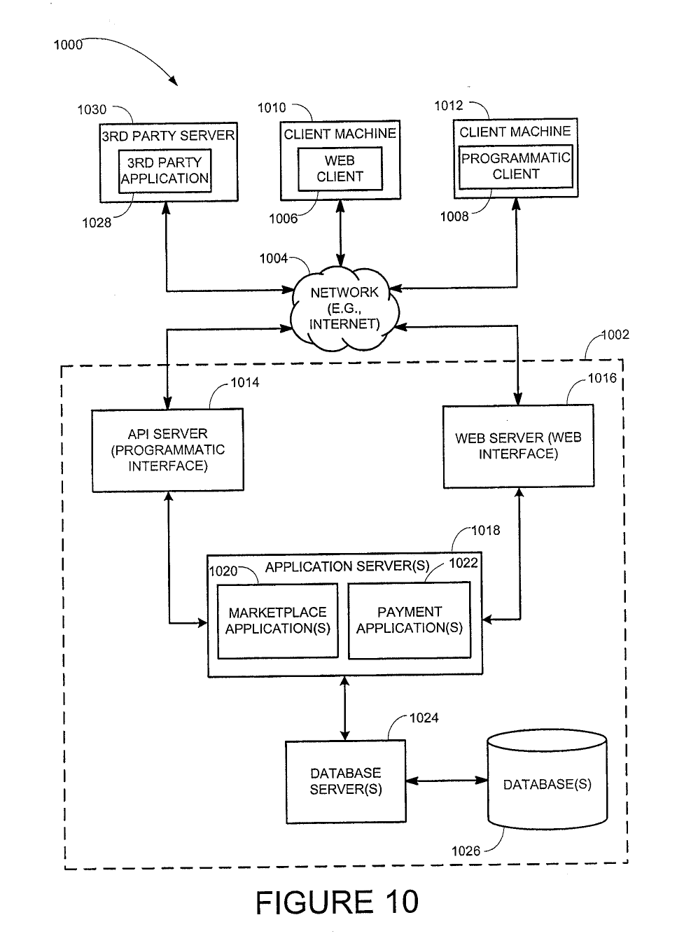

FIG. 10 is a network diagram depicting a client-server system 1000, within which one example embodiment may be deployed. By way of example, a network 1004 may include the functionality of the network 104, the payment processor 106 may be deployed within an application server 1018, and the client machine 102 may include the functionality of a client machine 1010 or a client machine 1012. The system 100 may also be deployed in other systems.

A networked system 1002, in the example forms of a network-based marketplace or publication system, provides server-side functionality, via a network 1004 (e.g., the Internet or Wide Area Network (WAN)) to one or more clients. FIG. 10 illustrates, for example, a web client 1006 (e.g., a browser, such as the Internet Explorer browser developed by Microsoft Corporation of Redmond, Wash. State), and a programmatic client 1008 executing on respective client machines 1010 and 1012.

An Application Program Interface (API) server 1014 and a web server 1016 are coupled to, and provide programmatic and web interfaces respectively to, one or more application servers 1018. The application servers 1018 host one or more marketplace applications 1020 and authentication providers 1022. The application servers 1018 are, in turn, shown to be coupled to one or more databases servers 1024 that facilitate access to one or more databases 1026.

The marketplace applications 1020 may provide a number of marketplace functions and services to users that access the networked system 1002. The authentication providers 1022 may likewise provide a number of payment services and functions to users. The authentication providers 1022 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 1020. While the marketplace and authentication providers 1020 and 1022 are shown in FIG. 10 to both form part of the networked system 1002, in alternative embodiments the authentication providers 1022 may form part of a payment service that is separate and distinct from the networked system 1002.

Further, while the system 1000 shown in FIG. 10 employs a client-server architecture, the present invention is of course not limited to such an architecture, and could equally well find application in a distributed, or peer-to-peer, architecture system, for example. The various marketplace and authentication providers 1020 and 1022 could also be implemented as standalone software programs, which need not have networking capabilities.

The web client 1006 accesses the various marketplace and authentication providers 1020 and 1022 via the web interface supported by the web server 1016. Similarly, the programmatic client 1008 accesses the various services and functions provided by the marketplace and authentication providers 1020 and 1022 via the programmatic interface provided by the API server 1014. The programmatic client 1008 may, for example, be a seller application (e.g., the TurboLister™ application developed by eBay Inc., of San Jose, Calif.) to enable sellers to author and manage listings on the networked system 1002 in an off-line manner, and to perform batch-mode communications between the programmatic client 1008 and the networked system 1002.

FIG. 10 also illustrates a third party application 1028, executing on a third party server machine 1030, as having programmatic access to the networked system 1002 via the programmatic interface provided by the API server 1014. For example, the third party application 1028 may, utilizing information retrieved from the networked system 1002, support one or more features or functions on a website hosted by the third party. The third party may, for example, provide one or more promotional, marketplace or payment functions that are supported by the relevant applications of the networked system 1002.

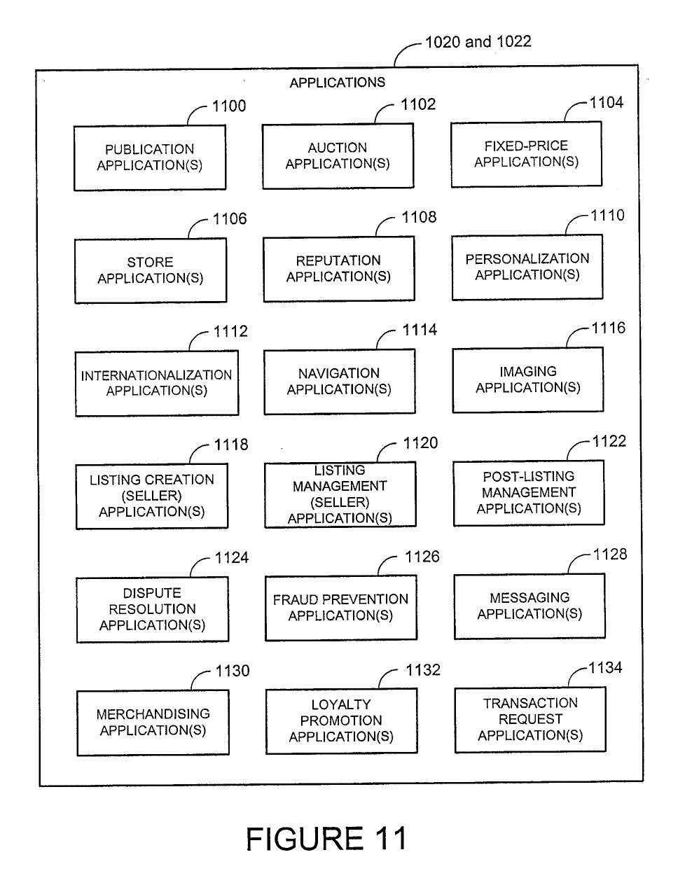

FIG. 11 is a block diagram illustrating multiple applications 1020 and 1022 that, in one example embodiment, are provided as part of the networked system 1002 (see FIG. 10). The applications 1020 may be hosted on dedicated or shared server machines (not shown) that are communicatively coupled to enable communications between server machines The applications themselves are communicatively coupled (e.g., via appropriate interfaces) to each other and to various data sources, so as to allow information to be passed between the applications or so as to allow the applications to share and access common data. The applications may furthermore access one or more databases 1026 via the database servers 1024.

The networked system 1002 may provide a number of publishing, listing and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace applications 1020 are shown to include at least one publication application 1100 and one or more auction applications 1102 which support auction-format listing and price setting mechanisms (e.g., English, Dutch, Vickrey, Chinese, Double, Reverse auctions etc.). The various auction applications 1102 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 1104 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 1106 allow a seller to group listings within a “virtual” store, which may be branded and otherwise personalized by and for the seller. Such a virtual store may also offer promotions, incentives and features that are specific and personalized to a relevant seller.

Reputation applications 1108 allow users that transact, utilizing the networked system 1002, to establish, build and maintain reputations, which may be made available and published to potential trading partners. Consider that where, for example, the networked system 1002 supports person-to-person trading, users may otherwise have no history or other reference information whereby the trustworthiness and credibility of potential trading partners may be assessed. The reputation applications 1108 allow a user, for example through feedback provided by other transaction partners, to establish a reputation within the networked system 1002 over time. Other potential trading partners may then reference such a reputation for the purposes of assessing credibility and trustworthiness.

Personalization applications 1110 allow users of the networked system 1002 to personalize various aspects of their interactions with the networked system 1002. For example a user may, utilizing an appropriate personalization application 1110, create a personalized reference page at which information regarding transactions to which the user is (or has been) a party may be viewed. Further, a personalization application 1110 may enable a user to personalize listings and other aspects of their interactions with the networked system 1002 and other parties.

The networked system 1002 may support a number of marketplaces that are customized, for example, for specific geographic regions. A version of the networked system 1002 may be customized for the United Kingdom, whereas another version of the networked system 1002 may be customized for the United States. Each of these versions may operate as an independent marketplace, or may be customized (or internationalized and/or localized) presentations of a common underlying marketplace. The networked system 1002 may accordingly include a number of internationalization applications 1112 that customize information (and/or the presentation of information) by the networked system 1002 according to predetermined criteria (e.g., geographic, demographic or marketplace criteria). For example, the internationalization applications 1112 may be used to support the customization of information for a number of regional websites that are operated by the networked system 1002 and that are accessible via respective web servers 1016.

Navigation of the networked system 1002 may be facilitated by one or more navigation applications 1114. For example, a search application (as an example of a navigation application) may enable key word searches of listings published via the networked system 1002. A browse application may allow users to browse various category, catalogue, or system inventory structures according to which listings may be classified within the networked system 1002. Various other navigation applications may be provided to supplement the search and browsing applications.

In order to make listings available via the networked system 1002 as visually informing and attractive as possible, the marketplace applications 1020 may include one or more imaging applications 1116 utilizing which users may upload images for inclusion within listings. An imaging application 1116 also operates to incorporate images within viewed listings. The imaging applications 1116 may also support one or more promotional features, such as image galleries that are presented to potential buyers. For example, sellers may pay an additional fee to have an image included within a gallery of images for promoted items.

Listing creation applications 1118 allow sellers conveniently to author listings pertaining to goods or services that they wish to transact via the networked system 1002, and listing management applications 1100 allow sellers to manage such listings. Specifically, where a particular seller has authored and/or published a large number of listings, the management of such listings may present a challenge. The listing management applications 1100 provide a number of features (e.g., auto-relisting, inventory level monitors, etc.) to assist the seller in managing such listings. One or more post-listing management applications 1102 also assist sellers with a number of activities that typically occur post-listing. For example, upon completion of an auction facilitated by one or more auction applications 1002, a seller may wish to leave feedback regarding a particular buyer. To this end, a post-listing management application 1102 may provide an interface to one or more reputation applications 1108, so as to allow the seller conveniently to provide feedback regarding multiple buyers to the reputation applications 1108.

Dispute resolution applications 1114 provide mechanisms whereby disputes arising between transacting parties may be resolved. For example, the dispute resolution applications 1114 may provide guided procedures whereby the parties are guided through a number of steps in an attempt to settle a dispute. In the event that the dispute cannot be settled via the guided procedures, the dispute may be escalated to a merchant mediator or arbitrator.

A number of fraud prevention applications 1126 implement fraud detection and prevention mechanisms to reduce the occurrence of fraud within the networked system 1002.

Messaging applications 1128 are responsible for the generation and delivery of messages to users of the networked system 1002, such messages for example advising users regarding the status of listings at the networked system 1002 (e.g., providing “outbid” notices to bidders during an auction process or to provide promotional and merchandising information to users). Respective messaging applications 1128 may utilize any one have a number of message delivery networks and platforms to deliver messages to users. For example, messaging applications 1128 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 1130 support various merchandising functions that are made available to sellers to enable sellers to increase sales via the networked system 1002. The merchandising applications 1130 also operate the various merchandising features that may be invoked by sellers, and may monitor and track the success of merchandising strategies employed by sellers.

The networked system 1002 itself, or one or more parties that transact via the networked system 1002, may operate loyalty programs that are supported by one or more loyalty/promotions applications 1132. For example, a buyer may earn loyalty or promotions points for each transaction established and/or concluded with a particular seller, and may be offered a reward for which accumulated loyalty points can be redeemed.

A transaction request application 1134 may transfer value to and/or from users of the networked system 1002. For example, a user purchasing an item with the auction application 1102 may pay for the item using the transaction request application 1134.

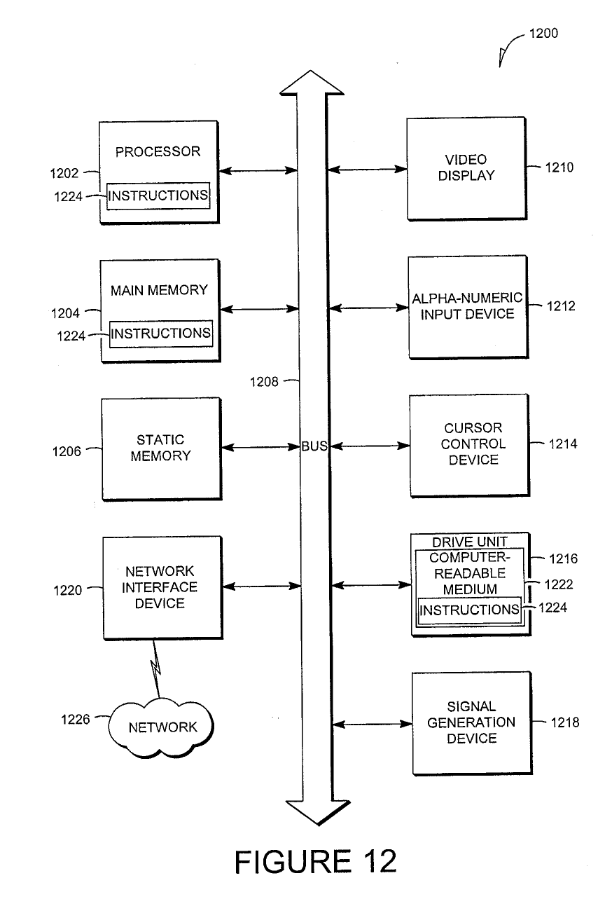

FIG. 12 shows a diagrammatic representation of machine in the example form of a computer system 1200 within which a set of instructions may be executed causing the machine to perform any one or more of the methods, processes, operations, or methodologies discussed herein. The payment processor 106 may operate on or more computer systems 1200. The client machine 102 may include the functionality of one or more computer systems 1200.

In an example embodiment, the machine operates as a standalone device or may be connected (e.g., networked) to other machines In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU) a graphics processing unit (GPU) or both), a main memory 1204 and a static memory 1206, which communicate with each other via a bus 1208. The computer system 1200 may further include a video display unit 1210 (e.g., a liquid crystal display (LCD) or a cathode ray tube (CRT)). The computer system 1200 also includes an alphanumeric input device 1212 (e.g., a keyboard), a cursor control device 1214 (e.g., a mouse), a drive unit 1216, a signal generation device 1218 (e.g., a speaker) and a network interface device 1220.

The drive unit 1216 includes a machine-readable medium 1222 on which is stored one or more sets of instructions (e.g., software 1224) embodying any one or more of the methodologies or functions described herein. The software 1224 may also reside, completely or at least partially, within the main memory 1204 and/or within the processor 1202 during execution thereof by the computer system 1200, the main memory 1204 and the processor 1202 also constituting machine-readable media.

The software 1224 may further be transmitted or received over a network 1226 via the network interface device 1220.

While the machine-readable medium 1222 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to include, but not be limited to, solid-state memories, optical and magnetic media, and carrier wave signals.

Certain systems, apparatus, applications or processes are described herein as including a number of modules or mechanisms. A module or a mechanism may be a unit of distinct functionality that can provide information to, and receive information from, other modules. Accordingly, the described modules may be regarded as being communicatively coupled. Modules may also initiate communication with input or output devices, and can operate on a resource (e.g., a collection of information). The modules be implemented as hardware circuitry, optical components, single or multi-processor circuits, memory circuits, software program modules and objects, firmware, and combinations thereof, as appropriate for particular implementations of various embodiments.

Thus, methods and systems for transaction processing have been described. Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system for conducting electronic transactions using text strings and default parameters over a network comprising:
a memory device; and
one or more processors in communication with the memory device and operable to:
receive a text string entered by a user;
determine a first portion of the text string corresponding to a transaction sender, a second portion of the text string corresponding to a transaction recipient, and a third portion of the text string corresponding to a transaction value, wherein the first, second, and third portions are sufficient to cause the system to execute a transfer of the transaction value from the transaction sender to the transaction recipient in accordance with a default parameter;
determine a fourth portion of the text string corresponding to an override parameter, wherein the fourth portion corresponds to an override parameter defining a different value than the default parameter; and
cause execution of a transfer of the transaction value from the transaction sender to the transaction recipient in accordance with the override parameter.

2. The system of claim 1, wherein the override parameter comprises a currency base, a target user identifier, a source user identifier, a fee transfer indicator, or combinations thereof.

3. The system of claim 1, wherein the first portion and second portion of the text string each comprise a user account identifier.

4. The system of claim 3, wherein the user account identifier comprises an e-mail address, a telephone number, or a token.

5. The system of claim 3, wherein the one or more processors are further operable to identify a target user account and source user account from the user account identifiers in the first portion and second portion of the text string.

6. The system of claim 1, wherein the one or more processors are further operable to configure one or more default parameters.

7. The system of claim 1, wherein the one or more processors are further operable to:
receive a status address;
generate a status identifier to indicate a status of a processing of the transfer request; and
provide the status identifier to the status address to provide a status notification.

8. The system of claim 1, wherein the one or more processors are further operable to:
receive user login information; and
verify access rights of a sender of the user login information, wherein processing of the transfer request is based on the verifying of the access rights.

9. A method for processing an electronic transfer request using text strings and default parameters over a network, the method comprising:
receiving, by a computer system, a text string entered by a user, wherein the text string is in a programmable scripting language;
determining, by the computer system, a first portion of the text string corresponding to a transaction sender, a second portion of the text string corresponding to a transaction recipient, and a third portion of the text string corresponding to a transaction value, wherein the first, second, and third portions are sufficient to cause the computer system to execute a transfer of the transaction value from the transaction sender to the transaction recipient in accordance with a default parameter;
determining, by the computer system, a fourth portion of the text string corresponding to an override parameter, wherein the fourth portion corresponds to an override parameter defining a different value than the default parameter; and
causing, by the computer system, execution of a transfer of the transaction value from the transaction sender to the transaction recipient in accordance with the override parameter.

10. The method of claim 9, wherein the override parameter comprises a currency base, a target user identifier, a source user identifier, a fee transfer indicator, or combinations thereof.

11. The method of claim 9, wherein the first portion of the text string comprises a source user account identifier and the second portion of the text string comprises a target user account identifier.

12. The method of claim 9, further comprising configuring one or more default parameters.

13. The method of claim 12, wherein the one or more default parameters comprise a default currency, a default number of target users, or combinations thereof.

14. The method of claim 9, further comprising verifying a user account.

15. The method of claim 14, wherein verifying the user account comprises:
receiving a verification request; and
providing an account verification responsive to the receiving of the verification request.

16. A non-transitory machine-readable medium comprising instructions, which when implemented by one or more processors perform a method comprising:
receiving a text string entered by a user;
determining a first portion of the text string corresponding to a transaction sender, wherein the transaction sender is the user, a second portion of the text string corresponding to a transaction recipient, and a third portion of the text string corresponding to a transaction value, wherein the first, second, and third portions are sufficient to cause the computer system to execute a transfer of the transaction value from the transaction sender to the transaction recipient in accordance with a default parameter;
determining a fourth portion of the text string corresponding to an override parameter, wherein the fourth portion corresponds to an override parameter defining a different value than the default parameter and the first, second, third, and fourth portions of the text string are in a programmable scripting language; and
causing execution of a transfer of the transaction value from the transaction sender to the transaction recipient in accordance with the override parameter.

17. The non-transitory machine-readable medium of claim 16, wherein the override parameter comprises a currency base, a target user identifier, a source user identifier, a fee transfer indicator, or combinations thereof.

18. The non-transitory machine-readable medium of claim 16, wherein the first portion of the text string comprises a source user account identifier and the second portion of the text string comprises a target user account identifier.

19. The non-transitory machine-readable medium of claim 18, wherein the source user account identifier and target user account identifier each comprise an e-mail address, a telephone number, or a token.

20. The non-transitory machine-readable medium of claim 16, wherein the method further comprises configuring one or more default parameters.
